(19) United States
(12) Patent Application Publication
(10) Pub. No.: US 2019/0043241 A1
(43) Pub. Date: Feb. 7, 2019

(54) GENERATING ANIMATIONS ON A SOCIAL-NETWORKING SYSTEM

(71) Applicant: Facebook, Inc., Menlo Park, CA (US)

(72) Inventors: Clark Scheff, Seattle, WA (US); Daniel Steinbock, Menlo Park, CA (US); Siyin Yang, Mercer Island, WA (US); Alexander Charles Granieri, Palo Alto, CA (US); Sridhar Rao, Palo Alto, CA (US); Upendra Shardanand, Seattle, WA (US); Eric Erkon Hsin, Seattle, WA (US)

(21) Appl. No.: 15/668,612

(22) Filed: Aug. 3, 2017

(51) Int. Cl. G06T 13/80; H04L 12/58; H04L 29/08; G06K 9/62

(52) U.S. Cl. CPC G06T 13/80; G06K 9/6215; H04L 67/10; H04L 51/32

(57) ABSTRACT

In one embodiment, a method includes receiving an image from a client system associated with a user of an online social network; detecting that a content item depicted in the image is located within a media space; selecting an animation template from a plurality of animations to apply to the image, wherein the selection of the animation is based on the detected content item or the media space; generating an animation based on the selected animation template and an image of the user; and sending, to the client system, instructions to display the animation on the client system associated with the user.

### TECHNICAL FIELD

This disclosure generally relates to generating an animation based on a received image and social-networking data.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, a method may provide for generating an animation based on a user generated image or video and one or more animation templates. In particular embodiments, a user of a social-networking system may capture an image or video and send it to the social-networking system for processing. The social-networking system may analyze the image or video and identify a media space within the image or video. The media space may have one or more content items. The social-networking system may detect these content items and apply one or more animation templates to the image based on (1) the recognized content item(s), and (2) social networking data associated with the user who captured the image and sent it to the social-networking system. The application of the animation template may constitute generating an animation based on the image or video and the animation template. The social-networking system may then send the animation to the user. As an example and not by way of limitation, a user, Tim, may take a photo of a media space that comprises a content item. In this example the media space may be a wall and the content item may be a movie poster for the movie Terminator, starring Arnold Schwarzenegger. Tim may send this photo to the social-networking system either as a message or by posting it to the online social network maintained by the social-networking system. The social-networking system may analyze the photo and recognize (e.g., via object recognition) that it contains the Terminator movie poster. The social-networking system may have stored on its servers one or more animation templates associated with the Terminator movie poster. If only one animation template for the Terminator movie is available, the social-networking system may select the animation template and apply it to the image in the location on the image where the movie poster is located. In this example, the animation template may comprise flashing lasers to be situated in the corner of the movie poster as well as red Terminator eyes that flash periodically. The animation template may further comprise flashing text that says “I'll be back.” The social-networking system may apply the animation template to the photo in the area where the Terminator movie poster is located to create an animation such that the movie poster appears to have lasers, flashing red eyes, and changing text. The social-networking system may send the image and the animation template as a single animation object to the user. The user may then post the animation object to the online social network, send the animation object to friends, or perform any other suitable function with the animation object. The animation object may be associated with social-networking data, such as user interaction, that may be displayed as users interact with the animation object (e.g., likes, reactions, shares, and comments may be displayed along with usernames of users who interacted with the animation object).

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example image with a content item that may be sent to the social-networking system for processing.

FIG. 1B illustrates an example image that has been processed by the social-networking system and has received an animation template.

FIG. 2 illustrates an example poster.

FIGS. 3A, 3B, and 3C illustrate another example poster.

FIG. 4 illustrates an example method for generating an animation based on a user generated image and one or more animation templates.

FIG. 5 illustrates an example network environment associated with a social-networking system.

FIG. 6 illustrates an example social graph.

FIG. 7 illustrates an example computer system.

### DESCRIPTION OF EXAMPLE EMBODIMENTS

In particular embodiments, a method may provide for applying one or more animation templates to an image or video. In particular embodiments, a user of a social-networking system may capture an image or video and send it to the social-networking system for processing. The social-networking system may analyze the image or video and identify a media space within the image. The media space may have one or more content items. The social-networking system may recognize these content items and apply one or more animation templates to the image or video based on (1) the recognized content item(s), and (2) social networking data associated with the user who captured the image or video and sent it to the social-networking system. The social-networking system may then send the animation to the user. As an example and not by way of limitation, a user, Tim, may take a photo of a media space that comprises a content item. In this example the media space may be a wall and the content item may be a movie poster for the movie Terminator, starring Arnold Schwarzenegger. Tim may send this photo to the social-networking system either as a message or by posting it to the online social network maintained by the social-networking system. The social-networking system may analyze the photo and recognize (e.g., via object recognition) that it contains the Terminator movie poster. The social-networking system may have stored on its servers one or more animation templates associated with the Terminator movie poster. If only one animation template for the Terminator movie is available, the social-networking system may select the animation template and apply it to the image in the location on the image where the movie poster is located. In this example, the animation template may comprise flashing lasers to be situated in the corner of the movie poster as well as red Terminator eyes that flash periodically. The animation template may further comprise flashing text that says “I'll be back.” The social-networking system may apply the animation template to the photo in the area where the Terminator movie poster is located so that the movie poster appears to have lasers, flashing red eyes, and changing text. The social-networking system may send the image and the animation template as a single animation object to the user. The user may then post the animation object to the online social network, send the animation object to friends, or perform any other suitable function with the animation object.

In particular embodiments, a server computing machine associated with a social-networking system may receive an image from a client system associated with a first user (or sending user) of an online social network. In particular embodiments, the image may be a plurality of images constituting a video. As an example and not by way of limitation, Tim may be a user of an online social network. Tim may also own a client system, such as a smart phone. Tim may use a camera on his smart phone to capture an image and send it to the social-networking system. As an example and not by way of limitation, the image may be a selfie of Tim standing in front of a movie poster for The Terminator. Sending the image to the social-networking system may comprise posting it to the online social network, sending the image in a message to a bot associated with the social-networking system, or any other suitable means of sending an image to a server. In particular embodiments, an action of the user may trigger an animation template process that is performed either on the user's client system or by the server computing device. Animation template process may mean the process that the social-networking system performs to detect a content item within a received image, selecting an animation template, generating an animation based on the animation template and an image of the user, and sending instructions to display the animation. The action of the user to trigger the animation template process may be any suitable action, including messaging a dedicated bot that is programmed to receive images and facilitate the animation template process, or by posting the image to the online social network and providing as a comment a particular hashtag, or by any other suitable means. In particular embodiments, the animation template process may be triggered when a user's client system is located within a threshold distance from a wireless beacon device (e.g., a Bluetooth device, a Wi-Fi router). As an example and not by way of limitation, the image may be a selfie of Tim standing in front of a movie poster for the Terminator movie. In the example of the user triggering the animation template process by providing a particular hashtag, the movie poster may contain a message that says “Post on Facebook and use the hashtag “TerminatorLive” to see a new animation.” Tim may follow these instructions so that the social-networking system receives the image along with the hashtag (e.g., #TerminatorLive). In particular embodiments, the use of the hashtag may trigger the social-networking system to begin the process of selecting an animation template and generating an animation as described herein. In particular embodiments, the photo may be taken by an in-venue camera instead of a client system associated with a user. In such a situation, an in-venue camera may be set up in a location to take a photo. The in-venue camera may be associated with a matrix barcode (e.g., a QR CODE) that a user may scan and send to the social-networking system. In particular embodiments, an automated messaging bot may simply create a mutual-message thread with the user and the social-networking system when the user's client system moves to within a threshold proximity of a wireless beacon. When the user sends the barcode to the social-networking system, or otherwise properly triggers the process, the in-venue camera may capture the image and send the image to the social-networking system for processing. Although this disclosure describes receiving an image from a client system in a particular manner, this disclosure contemplates receiving an image from a client system in any suitable manner.

In particular embodiments, the trigger for starting the animation template process may be made without the social-networking system receiving an image. In particular embodiments, the animation template process may be triggered when a user enters a particular geographic location (e.g., an area where a poster is located). The social-networking system may detect that a user is within a threshold distance of a poster or other content item or media space. Detection may be made by GPS data or by Bluetooth or other NFC detection. As an example and not by way of limitation, the social-networking system may receive an indication that a user has just connected with a Bluetooth or Wi-Fi signal associated with a media space or content item. In particular embodiments, when the social-networking system receives the trigger, it may send a notification or message to the user, inviting the user to begin the animation template process. As an example and not by way of limitation, a user, Amy, may come within a threshold distance (e.g., 25 feet) of a movie poster for WONDER WOMAN. The social-networking system may detect this using any one or more of the methods described herein and may send a message to a client system associated with Amy. The message may say, “Amy, show your friends your best Wonder Woman pose. Reply yes for instructions.” Alternatively, Amy may select to receive more instructions by tapping an appropriate icon on the message. If Amy chooses to receive more instructions, the social-networking system may instruct her to stand in front of the WONDER WOMAN poster and also instruct her to face a particular direction. If the animation template is interactive, the instructions may be more detailed. To extend the above example, the animation template may be configured to show Amy handling the Lasso of Truth (Wonder Woman's primary weapon of choice). The social-networking system may instruct Amy to place her hands a certain way or to make particular movements so that the animation template may be applied to a video of Amy and the animation may show Amy handling the Lasso of Truth. Although this disclosure describes a particular animation process carried out in a particular manner, this disclosure contemplates any suitable animation process carried out in any suitable manner.

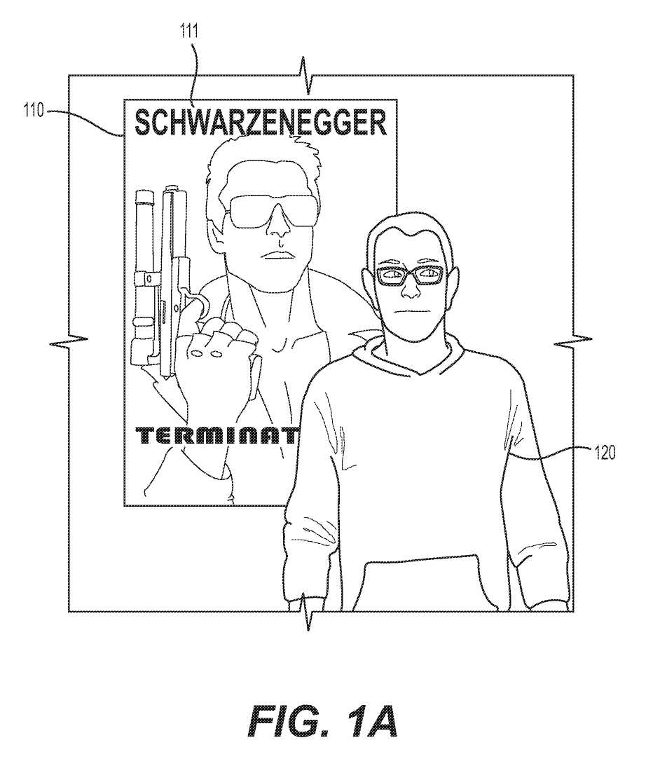

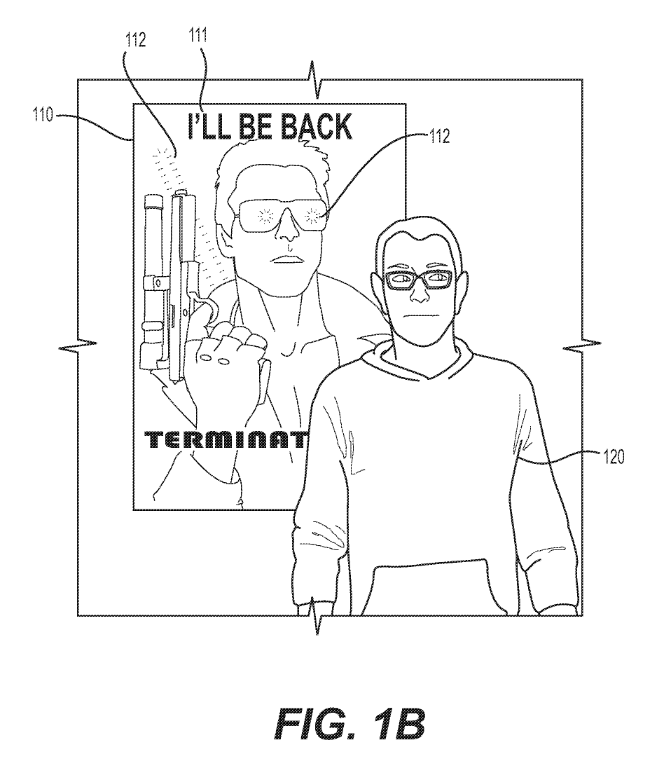

FIG. 1A illustrates an example image with a content item 110 that may be sent to the social-networking system for processing. The image may comprise a content item 110 (e.g., a movie poster) that is positioned within a media space (e.g., the wall on which poster 110 is affixed). The image may comprise any other suitable objects or content, such as a user 120. The content item itself may comprise content, such as text 111, or other images, such as a photograph of Arnold Schwarzenegger. Although this disclosure describes a particular image having a particular set of features, this disclosure contemplates any suitable image having any suitable features.

FIG. 1B illustrates an example animation that has been generated in association with the animation template process. The image in FIG. 1B may substantially resemble the image in FIG. 1A, with one or more animations that may be overlain on the image. An animation template may be understood to mean any element, static or dynamic, that may be used by the social-networking system to create an animation in conjunction with a received image. As an example and not by way of limitation, a received image may comprise a content item 110 (e.g., a Terminator movie poster). The animation template may comprise one or more animation features 111, 112. These animation features may be referred to individually, as individual animation features, or they may be referred to as a single animation template that is applied to an image or is otherwise used in conjunction with an image to create an animation. In the example of FIG. 1B, the animation template comprises element 112, which may be an animation of a laser beam. The animation may be moving (e.g., the movie poster may appear to have laser beams shooting across the background behind Arnold's head), or stationary (e.g., the laser beams may not move). As another example of an animation template or animation feature, the image of FIG. 1B may also include flashing red dots that appear over Arnold's sunglasses. As another example of an animation template or animation feature, the image of FIG. 1B may also include text 111 that changes from “Schwarzenegger” to “I'll be back.” Although this disclosure describes a particular image having a particular set of animation features, this disclosure contemplates any suitable image having any suitable features, including any suitable animation features.

In particular embodiments, the social-networking system may detect, within the image, a media space. The media space may be any suitable space upon which media may be placed, either physically or virtually (e.g., in augmented reality). Examples of media spaces include walls, sides of cars and buses, open spaces such as the sky, or any other substantially uncluttered space. Other examples of media spaces include billboards, flyers, bumper stickers, retail store signs, retail store window displays, an image on a computer screen, business cards, greeting cards, restaurant menus, t-shirts and other apparel, clothing labels, food packaging, book and magazine covers, music album covers or any other suitable area on which content may be displayed. In particular embodiments, the media space may contain a content item. The content item may be any suitable two-dimensional or three-dimensional item of content. Examples of content items may include movie posters (e.g., the Terminator movie poster of FIGS. 1A and 1B), advertisements (e.g., an advertisement on the side of a city bus for a Mexican restaurant called “Abuelo's: the Flavor of Mexico), logos or corporate marketing material (e.g., a NIKE swoosh, the ADIDAS logo), symbols (e.g., a traffic sign), names and titles (e.g., the name on a business card, the title of an album cover that says “Purpose: Justin Bieber”), or any other suitable content. In particular embodiments, the social-networking system may identify the content item within the media space. In particular embodiments, the social-networking system may store many copies of different content items and identify a received content item by comparing the received content item to the copies of content items stored on its servers. As an example and not by way of limitation, the social-networking system may store some or all of the movie posters generated in the last two years. When the social-networking system receives an image and along with an appropriate trigger to begin the animation template process, the social-networking system may analyze the image to first identify that a content item is present in the image. This may be accomplished through object recognition; the social-networking system may recognize that a rectangle appears in the image, and it may conclude that there is a substantial likelihood that the rectangle is a movie poster. In particular embodiments, the social-networking system may isolate the rectangle and compare it to the content items stored on its servers. If the content of the rectangle matches or substantially matches a content item stored in association with the social-networking system, the social-networking system may be deemed to have identified the content item. Although this disclosure describes identifying a content item in a particular manner, this disclosure contemplates identifying a content items in any suitable manner.

In particular embodiments, to enhance the sending user's experience with the animation template, the social-networking system may access a social graph associated with the online social network. As explained in more detail below, a social-networking system may maintain a social graph. The social graph may comprise a plurality of nodes and a plurality of edges connecting the nodes. Each edge connecting two of the nodes may correspond to a relationship between the two nodes. For example, if a user Alex has an edge connection to another user, Alison, this may correspond to a friend relationship or other first-degree connection between Alex and Alison. Edge connections may exist between users and users, users and concepts (e.g., football, sous vide cooking), users and entities (e.g., the Green Bay Packers, NIKE). The edge connections may correspond to friend relationships, “following” relationships, “like” relationships, or any other suitable relationships. In particular embodiments, the social graph may comprise a first node that corresponds to a producer. The social graph may also comprise a plurality of second nodes that each correspond to users of the social-networking system. The purpose of accessing the social graph in the context of animation templates may be to identify a particular animation template that the user may be more likely to engage with. As an example and not by way of limitation, the social-networking system may have stored on its servers two different animation templates for the Terminator movie poster. The first animation template may have blue lasers and blue glowing eyes and the second may have red lasers and red glowing eyes. The social graph may indicate that the sending user prefers the color blue (e.g., via an edge connection between the node corresponding to the user and a concept node corresponding to the color blue, or via any other suitable means). In this case, the social-networking system may send the first animation template and not the second, because the sending user prefers blue to red. As another (perhaps more relevant) example and not by way of limitation, consider the Twilight movies. Summit Entertainment produced and released five motion pictures based on four novels by American author Stephanie Meyer. The story focuses on the personal relationship between a human teenager Bella Swan (played by Kristen Stewart) and two other characters, both vying for her attention: Edward Cullen, a vampire played by Robert Pattinson, and a werewolf named Jacob Black (played by Tayler Lautner). A major theme of the series is Bella's angst over whether she should choose Edward or Jacob as her life-long love interest. This understandably led to a monumental debate spanning nearly ten years and involving millions of teenage girls about who Bella should choose. Those wanting her to pick Edward were known as being part of “Team Edward,” and those wanting her to pick Jacob were part of “Team Jacob.” Now consider a user Alex, who is a huge fan of the Twilight series. Alex may have taken various actions on the online social network that increased an affinity score between Alex's user node and a concept node corresponding to “Team Jacob.” Thus, Alex may be on Team Jacob. As an example, Alex may have joined a group on the online social network called “Team Jacob 4 Life!” Alternatively, or in addition, Alex may have liked, commented on or shared photographs of the actor who plays Jacob Black in the Twilight Movie series: Taylor Lautner. In any case, the social-networking system may determine that Alex has a greater affinity toward Jacob and Team Jacob than she does for Edward and Team Edward. Although this disclosure describes accessing a social graph in a particular manner, this disclosure contemplates accessing a social graph in any suitable manner.

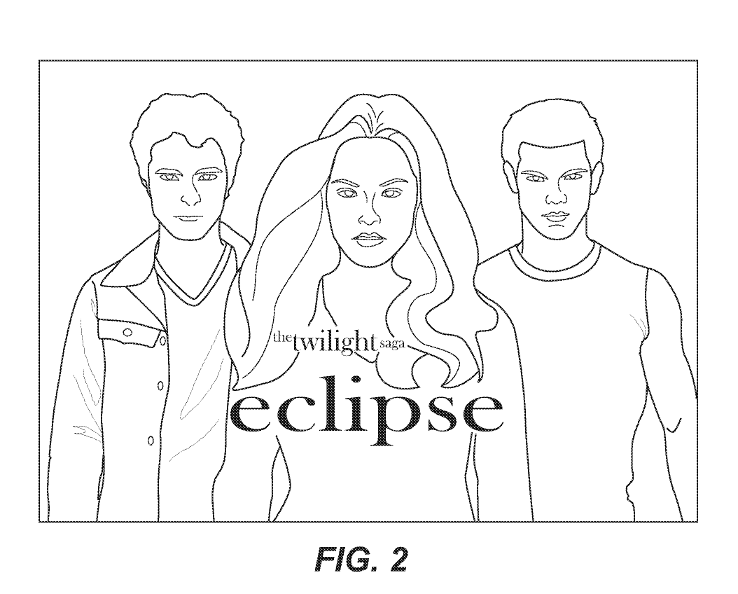

FIG. 2 illustrates an example movie poster. This movie poster may be similar to a movie poster used to promote the movie TWILIGHT: ECLIPSE. In particular embodiments, the social-networking system may select an animation template from a plurality of animation templates to apply to the image, wherein the selection of the animation template is based on: the one or more content items within the media space; and one or more of the second nodes that are connected by an edge to the first node. Continuing the example, Alex may take a photo of the movie poster of FIG. 2 and send it to the social-networking system with an appropriate trigger to begin the animation template process. The social-networking system may have two animation templates for this particular movie poster. The first may depict Edward (on the left side of the movie poster) moving to the forefront of the poster and Jacob (right side) slowly fading until he disappears. This animation template may be meant for Team Edward fans. A second animation template may show Jacob moving to the forefront of the poster and Edward slowly fading until he disappears. This animation template may be meant for Team Jacob fans. Both animation templates may also include the text: “Who will win Bella's heart? Find out June 24.” When Alex triggers the animation template process, the social-networking system may access the social graph and determine that Alex has a greater affinity for Team Jacob and for Team Edward. As a result, the social-networking system may select the second animation template. Although this disclosure describes accessing a social graph in a particular manner, this disclosure contemplates accessing a social graph in any suitable manner.

In particular embodiments, the animation may be interactive. The interactive component of the animation may be executed by the social-networking system. The process may function as follows: the social-networking system may identify a user in the image that it receives and may determine the user's location in relation to the content item (e.g., movie poster) and various sub-items inside the content item. The social-networking system may then generate an animation or alter a pre-existing animation to be directed toward the location in which the user is positioned in the image. To continue the above TWILIGHT example, Alex may pose with the movie poster for TWILIGHT: ECLIPSE. She may be standing next to Jacob (on the right side of FIG. 2) and may be gazing lovingly into Jacobs's eyes. The animation template may have an interactive component in which Jacob looks back at Alex and winks at her. Although this disclosure describes providing a particular interactive animation in a particular manner, this disclosure contemplates providing any suitable interactive animation in any suitable manner.

In particular embodiments, the selection may be further based on a current location of the client system of the sending user. When a user uses his client system to send an image to the social-networking system and trigger the animation template process, the client system may have location services enabled, and may also transmit its current location to the social-networking system. The social-networking system may use the current location of the client system as a factor in selecting an animation template. Location information may be used to promote various products or services that are close to the user when she sends the image and triggers the animation template process. As an example and not by way of limitation, MCDONALD'S may be promoting $1 soft drinks at their location on Broadway Street in New York City. MCDONALD'S may partner with the social-networking system such that animations sent to client systems located within a one-mile radius of the MCDONALD'S on Broadway Street include an advertisement for the $1 soft drinks. Thus, if a user captures an image of a content item (e.g., a movie poster or a poster for a Broadway show) at the Fulton Street subway station and sends it to the social-networking system for an animation template, the animation template may include the advertisement for $1 soft drinks. Although this disclosure describes basing a selection of an animation template on location data in a particular manner, this disclosure contemplates basing a selection of an animation template on location data in any suitable manner.

In particular embodiments, the selection of the animation template may be based on a sequence of animation templates that may be sent to a user in a particular order. Advertisers or promoters of movies may wish to engage users by incentivizing them to locate several content items. In particular embodiments, users may earn prizes or access based on the content items they have located and sent to the social-networking system for animation templates. As an example and not by way of limitation, DISNEY may wish to promote a new STAR WARS movie and may have created several different movie posters for the movie, each depicting a different character. The movie posters may be placed in several different locations across Downtown Disney in Southern California. When a user sends an image of one of the movie posters to the social-networking system for an animation template, the animation template may include a text prompt that says “Collect all four posters to unlock unseen footage.” This may entice the user to search for the other three movie posters, capture an image of each, and send them to the social-networking system for animation templates, like a scavenger hunt. Although this disclosure describes selecting an animation template in a particular manner, this disclosure contemplates selecting an animation template in any suitable manner.

In particular embodiments, the selection of the animation template may be further based on a threshold number of users interacting with an image having the selected animation template. The social-networking system may wish to use the animation templates that will increase engagement among users. The social-networking system may store two or more animation templates for a particular content item. The social-networking system may apply each of the two or more animation templates to appropriate images in a random fashion to generate animations for users. The social-networking system may monitor user engagement with animations generated based on each of the animation templates as applied to the appropriate images. If animations generated from a particular animation template receive more user engagement than animations generated from other animation templates, the social networking system may apply the more popular animation template more often than the less popular animation templates. In this disclosure, more popular animation templates may be those animation templates used to create animations that have more edges connecting to their corresponding nodes than nodes corresponding to other animations involving the same content item but a different animation template. More edge connections may signify that more users have liked, reacted to, commented on, shared, or otherwise interacted with the content object. Although this disclosure describes selecting an animation template in a particular manner, this disclosure contemplates selecting an animation template in any suitable manner.

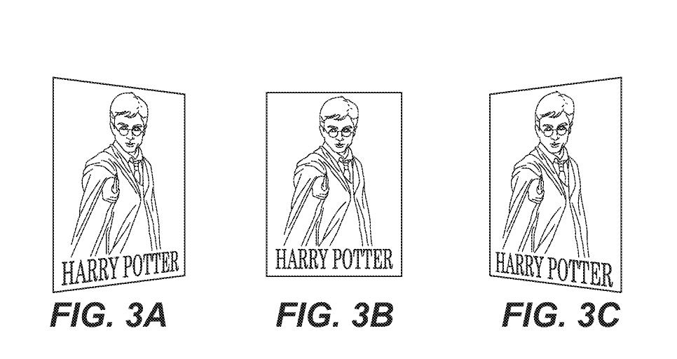

FIGS. 3A-3C illustrate an example animation that has a changing perspective. In particular embodiments, the animation may comprise a change in perspective in addition to the animated features discussed herein. A change in perspective may be understood to mean that the perceived camera angle appears to shift from a first viewpoint to at least one other viewpoint during the animation sequence. In the example of FIGS. 3A-3C, FIG. 3A depicts a HARRY POTTER movie poster that appears to be taken from the left side of the movie poster. FIG. 3B depicts the HARRY POTTER movie poster that appears to be taken from the front of the movie poster. FIG. 3C depicts the HARRY POTTER movie poster that appears to have been taken from the right side of the movie poster. The social-networking system may require a user to send a first image and at least one other image in order to generate an animation that has a changing perspective, or the social-networking system may generate an animation that has a changing perspective from a single image using computer graphics rendering techniques. In particular embodiments, the social-networking system may receive a first image. As an example and not by way of limitation, the social-networking system may receive an image of a HARRY POTTER movie poster as shown in FIG. 3B. In particular embodiments, the social-networking system may receive a second image from the client system, the second image comprising the media item, and wherein the second image was captured from a perspective that is different from the first image. As an example and not by way of limitation, the social-networking system may receive an image of the HARRY POTTER movie poster as shown in FIG. 3A. In particular embodiments, the social-networking system may identify, from the at least two images, a geometric object that is common to the at least two images. As an example and not by way of limitation, a geometric object common to FIGS. 3A and 3B may be the outline of the movie poster (e.g., a rectangle). In particular embodiments, the social-networking system may compute a difference in perspective between the at least two images that is based at least in part on a difference in size and shape between the geometric object in the first image and the geometric object in the second image. As an example and not by way of limitation, the social-networking system may process the two images depicted in FIGS. 3A and 3B to determine that the difference in perspective between the two images is 30 degrees. In other words, if the sending user was standing directly in front of the movie poster when she captured the image depicted in FIG. 3B, then the sending user was standing a few feet to the left of the movie poster such that the resulting change in perspective is 30 degrees. In particular embodiments, the social-networking system may generate, based on the difference in perspective, a transition animation to show a transition from the first image to the second image, wherein the transition animation comprises the first image, the second image, and the animation. The animation may show what appears to be a smooth transition from the first image to the second image, as if the image capture device was capturing a video of the subject as it rotated around the subject. Although this disclosure describes generating an animation in a particular manner, this disclosure contemplates generating an animation in any suitable manner.

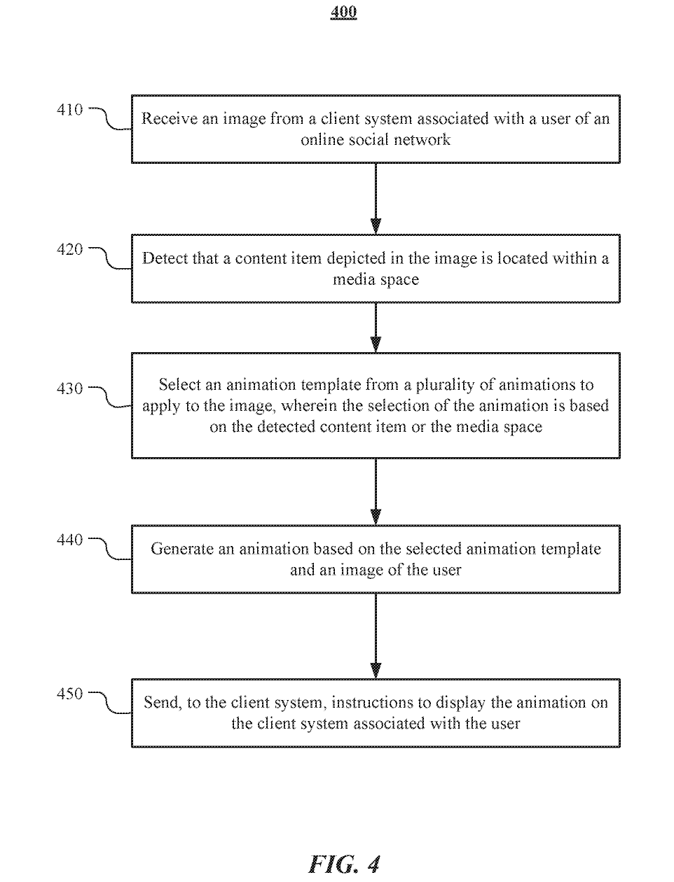

FIG. 4 illustrates an example method 400 for generating an animation based on a user generated image and one or more animation templates. The method may begin at step 410, where the social-networking system may receive an image from a client system associated with a user of an online social network. At step 420, the social-networking system may detect that a content item depicted in the image is located within a media space. At step 430, the social-networking system may select an animation template from a plurality of animations to apply to the image, wherein the selection of the animation is based on the detected content item or the media space. At step 440, the social-networking system may generate an animation based on the selected animation template and an image of the user. At step 450, the social-networking system may send, to the client system, instructions to display the animation on the client system associated with the user. In particular embodiments, the animation may be referred to as an animation object. The animation object may be associated with social-networking data, such as user interaction, that may be displayed as users interact with the animation object (e.g., likes, reactions, shares, and comments may be displayed along with usernames of users who interacted with the animation object). Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for generating an animation based on a user generated image and one or more animation templates including the particular steps of the method of FIG. 4, this disclosure contemplates any suitable method for generating an animation based on a user generated image and one or more animation templates including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

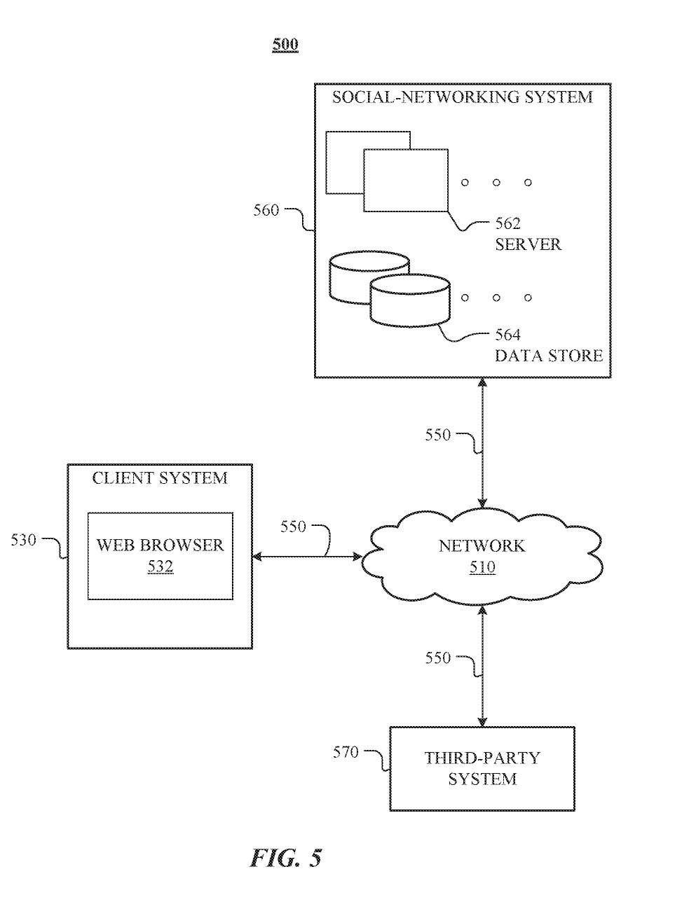

FIG. 5 illustrates an example network environment 500 associated with a social-networking system. Network environment 500 includes a client system 530, a social-networking system 560, and a third-party system 570 connected to each other by a network 510. Although FIG. 5 illustrates a particular arrangement of client system 530, social-networking system 560, third-party system 570, and network 510, this disclosure contemplates any suitable arrangement of client system 530, social-networking system 560, third-party system 570, and network 510. As an example and not by way of limitation, two or more of client system 530, social-networking system 560, and third-party system 570 may be connected to each other directly, bypassing network 510. As another example, two or more of client system 530, social-networking system 560, and third-party system 570 may be physically or logically co-located with each other in whole or in part. Moreover, although FIG. 5 illustrates a particular number of client systems 530, social-networking systems 560, third-party systems 570, and networks 510, this disclosure contemplates any suitable number of client systems 530, social-networking systems 560, third-party systems 570, and networks 510. As an example and not by way of limitation, network environment 500 may include multiple client system 530, social-networking systems 560, third-party systems 570, and networks 510.

This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 510 may include one or more networks 510.

Links 550 may connect client system 530, social-networking system 560, and third-party system 570 to communication network 510 or to each other. This disclosure contemplates any suitable links 550. In particular embodiments, one or more links 550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout network environment 500. One or more first links 550 may differ in one or more respects from one or more second links 550.

In particular embodiments, client system 530 may be an electronic device including hardware, software, or embedded logic components or a combination of two or more such components and capable of carrying out the appropriate functionalities implemented or supported by client system 530. As an example and not by way of limitation, a client system 530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 530. A client system 530 may enable a network user at client system 530 to access network 510. A client system 530 may enable its user to communicate with other users at other client systems 530.

In particular embodiments, client system 530 may include a web browser 532, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 530 may enter a Uniform Resource Locator (URL) or other address directing the web browser 532 to a particular server (such as server 562, or a server associated with a third-party system 570), and the web browser 532 may generate a Hyper Text Transfer Protocol (HTTP) request and communicate the HTTP request to server. The server may accept the HTTP request and communicate to client system 530 one or more Hyper Text Markup Language (HTML) files responsive to the HTTP request. Client system 530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 560 may be a network-addressable computing system that can host an online social network. Social-networking system 560 may generate, store, receive, and send social-networking data, such as, for example, user-profile data, concept-profile data, social-graph information, or other suitable data related to the online social network. Social-networking system 560 may be accessed by the other components of network environment 500 either directly or via network 510. As an example and not by way of limitation, client system 530 may access social-networking system 560 using a web browser 532, or a native application associated with social-networking system 560 (e.g., a mobile social-networking application, a messaging application, another suitable application, or any combination thereof) either directly or via network 510. In particular embodiments, social-networking system 560 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 562 may include hardware, software, or embedded logic components or a combination of two or more such components for carrying out the appropriate functionalities implemented or supported by server 562. In particular embodiments, social-networking system 560 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client system 530, a social-networking system 560, or a third-party system 570 to manage, retrieve, modify, add, or delete, the information stored in data store 564.

In particular embodiments, social-networking system 560 may store one or more social graphs in one or more data stores 564. In particular embodiments, a social graph may include multiple nodes—which may include multiple user nodes (each corresponding to a particular user) or multiple concept nodes (each corresponding to a particular concept)—and multiple edges connecting the nodes. Social-networking system 560 may provide users of the online social network the ability to communicate and interact with other users. In particular embodiments, users may join the online social network via social-networking system 560 and then add connections (e.g., relationships) to a number of other users of social-networking system 560 to whom they want to be connected. Herein, the term “friend” may refer to any other user of social-networking system 560 with whom a user has formed a connection, association, or relationship via social-networking system 560.

In particular embodiments, social-networking system 560 may provide users with the ability to take actions on various types of items or objects, supported by social-networking system 560. As an example and not by way of limitation, the items and objects may include groups or social networks to which users of social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 560 or by an external system of third-party system 570, which is separate from social-networking system 560 and coupled to social-networking system 560 via a network 510.

In particular embodiments, social-networking system 560 may be capable of linking a variety of entities. As an example and not by way of limitation, social-networking system 560 may enable users to interact with each other as well as receive content from third-party systems 570 or other entities, or to allow users to interact with these entities through an application programming interfaces (API) or other communication channels.

In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating social-networking system 560. In particular embodiments, however, social-networking system 560 and third-party systems 570 may operate in conjunction with each other to provide social-networking services to users of social-networking system 560 or third-party systems 570. In this sense, social-networking system 560 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client system 530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 560 also includes user-generated content objects, which may enhance a user's interactions with social-networking system 560. User-generated content may include anything a user can add, upload, send, or “post” to social-networking system 560. As an example and not by way of limitation, a user communicates posts to social-networking system 560 from a client system 530. Posts may include data such as status updates or other textual data, location information, photos, videos, links, music or other similar data or media. Content may also be added to social-networking system 560 by a third-party through a “communication channel,” such as a newsfeed or stream.

In particular embodiments, social-networking system 560 may include a variety of servers, sub-systems, programs, modules, logs, and data stores. In particular embodiments, social-networking system 560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 560 may also include suitable components such as network interfaces, security mechanisms, load balancers, failover servers, management-and-network-operations consoles, other suitable components, or any suitable combination thereof. In particular embodiments, social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 560 to one or more client systems 530 or one or more third-party system 570 via network 510. The web server may include a mail server or other messaging functionality for receiving and routing messages between social-networking system 560 and one or more client systems 530. An API-request server may allow a third-party system 570 to access information from social-networking system 560 by calling one or more APIs. An action logger may be used to receive communications from a web server about a user's actions on or off social-networking system 560. In conjunction with the action log, a third-party-content-object log may be maintained of user exposures to third-party-content objects. A notification controller may provide information regarding content objects to a client system 530. Information may be pushed to a client system 530 as notifications, or information may be pulled from client system 530 responsive to a request received from client system 530. Authorization servers may be used to enforce one or more privacy settings of the users of social-networking system 560. A privacy setting of a user determines how particular information associated with a user can be shared. The authorization server may allow users to opt in to or opt out of having their actions logged by social-networking system 560 or shared with other systems (e.g., third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

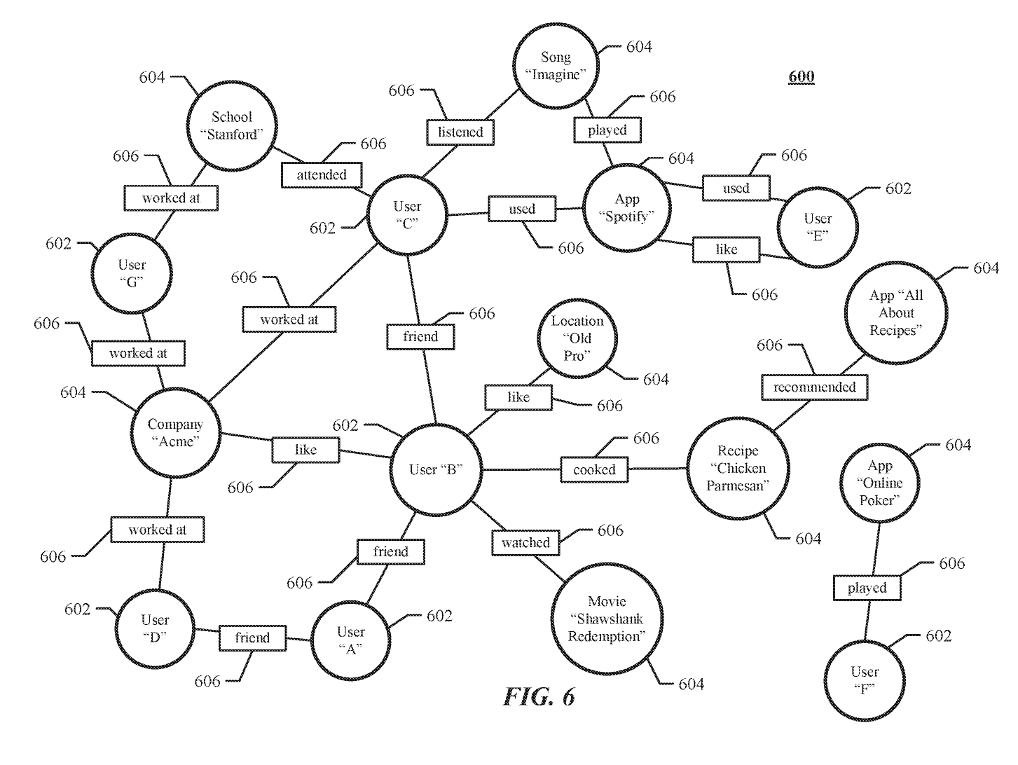

FIG. 6 illustrates example social graph 600. In particular embodiments, social-networking system 560 may store one or more social graphs 600 in one or more data stores. In particular embodiments, social graph 600 may include multiple nodes—which may include multiple user nodes 602 or multiple concept nodes 604—and multiple edges 606 connecting the nodes. Example social graph 600 illustrated in FIG. 6 is shown, for didactic purposes, in a two-dimensional visual map representation. In particular embodiments, a social-networking system 560, client system 530, or third-party system 570 may access social graph 600 and related social-graph information for suitable applications. The nodes and edges of social graph 600 may be stored as data objects, for example, in a data store (such as a social-graph database). Such a data store may include one or more searchable or queryable indexes of nodes or edges of social graph 600.

In particular embodiments, a user node 602 may correspond to a user of social-networking system 560. As an example and not by way of limitation, a user may be an individual (human user), an entity (e.g., an enterprise, business, or third-party application), or a group (e.g., of individuals or entities) that interacts or communicates with or over social-networking system 560. In particular embodiments, when a user registers for an account with social-networking system 560, social-networking system 560 may create a user node 602 corresponding to the user, and store the user node 602 in one or more data stores. Users and user nodes 602 described herein may, where appropriate, refer to registered users and user nodes 602 associated with registered users. In addition or as an alternative, users and user nodes 602 described herein may, where appropriate, refer to users that have not registered with social-networking system 560. In particular embodiments, a user node 602 may be associated with information provided by a user or information gathered by various systems, including social-networking system 560. As an example and not by way of limitation, a user may provide his or her name, profile picture, contact information, birth date, sex, marital status, family status, employment, education background, preferences, interests, or other demographic information. In particular embodiments, a user node 602 may be associated with one or more data objects corresponding to information associated with a user. In particular embodiments, a user node 602 may correspond to one or more webpages.

In particular embodiments, a concept node 604 may correspond to a concept. As an example and not by way of limitation, a concept may correspond to a place (such as, for example, a movie theater, restaurant, landmark, or city); a website (such as, for example, a website associated with social-network system 560 or a third-party website associated with a web-application server); an entity (such as, for example, a person, business, group, sports team, or celebrity); a resource (such as, for example, an audio file, video file, digital photo, text file, structured document, or application) which may be located within social-networking system 560 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 604 may be associated with information of a concept provided by a user or information gathered by various systems, including social-networking system 560. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 604 may be associated with one or more data objects corresponding to information associated with concept node 604. In particular embodiments, a concept node 604 may correspond to one or more webpages.

In particular embodiments, a node in social graph 600 may represent or be represented by a webpage (which may be referred to as a “profile page”). Profile pages may be hosted by or accessible to social-networking system 560. Profile pages may also be hosted on third-party websites associated with a third-party system 570. As an example and not by way of limitation, a profile page corresponding to a particular external webpage may be the particular external webpage and the profile page may correspond to a particular concept node 604. Profile pages may be viewable by all or a selected subset of other users. As an example and not by way of limitation, a user node 602 may have a corresponding user-profile page in which the corresponding user may add content, make declarations, or otherwise express himself or herself. As another example and not by way of limitation, a concept node 604 may have a corresponding concept-profile page in which one or more users may add content, make declarations, or express themselves, particularly in relation to the concept corresponding to concept node 604.

In particular embodiments, a concept node 604 may represent a third-party webpage or resource hosted by a third-party system 570. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 530 to send to social-networking system 560 a message indicating the user's action. In response to the message, social-networking system 560 may create an edge (e.g., a check-in-type edge) between a user node 602 corresponding to the user and a concept node 604 corresponding to the third-party webpage or resource and store edge 606 in one or more data stores.

In particular embodiments, a pair of nodes in social graph 600 may be connected to each other by one or more edges 606. An edge 606 connecting a pair of nodes may represent a relationship between the pair of nodes. In particular embodiments, an edge 606 may include or represent one or more data objects or attributes corresponding to the relationship between a pair of nodes. As an example and not by way of limitation, a first user may indicate that a second user is a “friend” of the first user. In response to this indication, social-networking system 560 may send a “friend request” to the second user. If the second user confirms the “friend request,” social-networking system 560 may create an edge 606 connecting the first user's user node 602 to the second user's user node 602 in social graph 600 and store edge 606 as social-graph information in one or more of data stores 564. In the example of FIG. 6, social graph 600 includes an edge 606 indicating a friend relation between user nodes 602 of user “A” and user “B” and an edge indicating a friend relation between user nodes 602 of user “C” and user “B.” Although this disclosure describes or illustrates particular edges 606 with particular attributes connecting particular user nodes 602, this disclosure contemplates any suitable edges 606 with any suitable attributes connecting user nodes 602. As an example and not by way of limitation, an edge 606 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 600 by one or more edges 606.

In particular embodiments, an edge 606 between a user node 602 and a concept node 604 may represent a particular action or activity performed by a user associated with user node 602 toward a concept associated with a concept node 604. As an example and not by way of limitation, as illustrated in FIG. 6, a user may “like,” “attended,” “played,” “listened,” “cooked,” “worked at,” or “watched” a concept, each of which may correspond to an edge type or subtype. A concept-profile page corresponding to a concept node 604 may include, for example, a selectable “check in” icon (such as, for example, a clickable “check in” icon) or a selectable “add to favorites” icon. Similarly, after a user clicks these icons, social-networking system 560 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 560 may create a “listened” edge 606 and a “used” edge (as illustrated in FIG. 6) between user nodes 602 corresponding to the user and concept nodes 604 corresponding to the song and application to indicate that the user listened to the song and used the application. Moreover, social-networking system 560 may create a “played” edge 606 (as illustrated in FIG. 6) between concept nodes 604 corresponding to the song and the application to indicate that the particular song was played by the particular application. In this case, “played” edge 606 corresponds to an action performed by an external application (SPOTIFY) on an external audio file (the song “Imagine”). Although this disclosure describes particular edges 606 with particular attributes connecting user nodes 602 and concept nodes 604, this disclosure contemplates any suitable edges 606 with any suitable attributes connecting user nodes 602 and concept nodes 604. Moreover, although this disclosure describes edges between a user node 602 and a concept node 604 representing a single relationship, this disclosure contemplates edges between a user node 602 and a concept node 604 representing one or more relationships. As an example and not by way of limitation, an edge 606 may represent both that a user likes and has used at a particular concept. Alternatively, another edge 606 may represent each type of relationship (or multiples of a single relationship) between a user node 602 and a concept node 604 (as illustrated in FIG. 6 between user node 602 for user “E” and concept node 604 for “SPOTIFY”).

In particular embodiments, social-networking system 560 may create an edge 606 between a user node 602 and a concept node 604 in social graph 600. As an example and not by way of limitation, a user viewing a concept-profile page (such as, for example, by using a web browser or a special-purpose application hosted by the user's client system 530) may indicate that he or she likes the concept represented by the concept node 604 by clicking or selecting a “Like” icon, which may cause the user's client system 530 to send to social-networking system 560 a message indicating the user's liking of the concept associated with the concept-profile page. In response to the message, social-networking system 560 may create an edge 606 between user node 602 associated with the user and concept node 604, as illustrated by “like” edge 606 between the user and concept node 604. In particular embodiments, social-networking system 560 may store an edge 606 in one or more data stores. In particular embodiments, an edge 606 may be automatically formed by social-networking system 560 in response to a particular user action. As an example and not by way of limitation, if a first user uploads a picture, watches a movie, or listens to a song, an edge 606 may be formed between user node 602 corresponding to the first user and concept nodes 604 corresponding to those concepts. Although this disclosure describes forming particular edges 606 in particular manners, this disclosure contemplates forming any suitable edges 606 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 560). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 560 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 560) or RSVP (e.g., through social-networking system 560) to an event associated with the advertisement. In addition or as an alternative, an advertisement may include social-networking-system content directed to the user. As an example and not by way of limitation, an advertisement may display information about a friend of the user within social-networking system 560 who has taken an action associated with the subject matter of the advertisement.

In particular embodiments, social-networking system 560 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 570 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 560 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 560 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 560 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 560 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 560 may calculate a coefficient based on a user's actions. Social-networking system 560 may monitor such actions on the online social network, on a third-party system 570, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 560 may calculate a coefficient based on the user's actions with particular types of content. The content may be associated with the online social network, a third-party system 570, or another suitable system. The content may include users, profile pages, posts, news stories, headlines, instant messages, chat room conversations, emails, advertisements, pictures, video, music, other suitable objects, or any combination thereof. Social-networking system 560 may analyze a user's actions to determine whether one or more of the actions indicate an affinity for subject matter, content, other users, and so forth. As an example and not by way of limitation, if a user frequently posts content related to “coffee” or variants thereof, social-networking system 560 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 560 may calculate a coefficient based on the type of relationship between particular objects. Referencing the social graph 600, social-networking system 560 may analyze the number and/or type of edges 606 connecting particular user nodes 602 and concept nodes 604 when calculating a coefficient. As an example and not by way of limitation, user nodes 602 that are connected by a spouse-type edge (representing that the two users are married) may be assigned a higher coefficient than a user nodes 602 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 560 may determine that the user has a higher coefficient with respect to the first photo than the second photo because having a tagged-in-type relationship with content may be assigned a higher weight and/or rating than having a like-type relationship with content. In particular embodiments, social-networking system 560 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 560 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 600. As an example and not by way of limitation, social-graph entities that are closer in the social graph 600 (i.e., fewer degrees of separation) may have a higher coefficient than entities that are further apart in the social graph 600.

In particular embodiments, social-networking system 560 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 530 of the user). A first user may be more interested in other users or concepts that are closer to the first user. As an example and not by way of limitation, if a user is one mile from an airport and two miles from a gas station, social-networking system 560 may determine that the user has a higher coefficient for the airport than the gas station based on the proximity of the airport to the user.

In particular embodiments, social-networking system 560 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 560 may provide information that is relevant to user's interests and current circumstances, increasing the likelihood that they will find such information of interest. In particular embodiments, social-networking system 560 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 560 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 560 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 570 (e.g., via an API or other communication channel), or from another suitable system. In response to the request, social-networking system 560 may calculate the coefficient (or access the coefficient information if it has previously been calculated and stored). In particular embodiments, social-networking system 560 may measure an affinity with respect to a particular process. Different processes (both internal and external to the online social network) may request a coefficient for a particular object or set of objects. Social-networking system 560 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

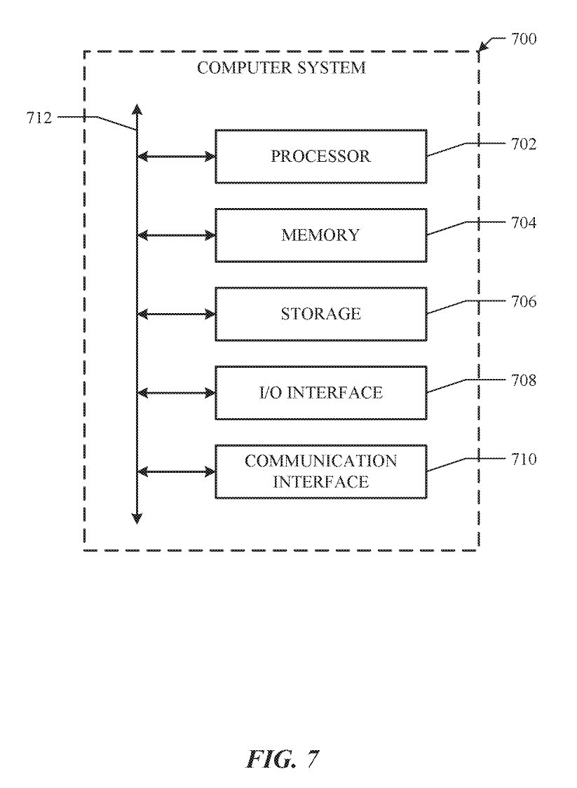

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computer server machines:
receiving an image from a client system associated with a user of an online social network;
detecting that a content item depicted in the image is located within a media space;
selecting an animation template from a plurality of animations to apply to the image, wherein the selection of the animation is based on the detected content item or the media space;
generating an animation based on the selected animation template and an image of the user; and
sending, to the client system, instructions to display the animation on the client system associated with the user.

2. The method of claim 1, wherein the selection of the animation template is further based on a current location associated with the client system.

3. The method of claim 1, wherein the content item comprises a poster.

4. The method of claim 1, wherein the animation template is selected from a plurality of animation templates, wherein each animation template corresponds to a particular content item of a plurality of content items.

5. The method of claim 1, wherein the animation template is selected further based on social graph information comprised in a social graph, the social graph comprising a plurality of nodes and a plurality of edges connecting the nodes, and wherein:
a first node corresponds to the user;
a plurality of second nodes each correspond to a particular second user, entity, or concept associated with the online social network; and
one or more edges connect the first node to one or more of the plurality of second nodes.

6. The method of claim 1, wherein the image is a first image, and further comprising:
receiving a second image from the client system, wherein the first image and the second image both comprise the content item, and the second image of the at least two images comprises a perspective of the content item that is different than the first image;
identifying, from the at least two images, an object that is common to the at least two images;
computing a difference in perspective between the at least two images that is based at least in part on a difference in size and shape between the object in the first image and the object in the second image; and
generating, based on the difference in perspective, an animation to illustrate a transition from the first image to the second image.

7. The method of claim 1, wherein the animation comprises one or more interactive elements.

8. The method of claim 1, wherein the selection of the animation template is further based on a threshold number of users interacting with the animation.

9. The method of claim 1, wherein the image of the user is extracted from the received image depicted within the image.

10. The method of claim 1, wherein the image of the user is retrieved from a database maintained by the social-networking system.

11. One or more computer-readable non-transitory storage media embodying software that is operable when executed to:
receive an image from a client system associated with a user of an online social network;
detect that a content item depicted in the image is located within a media space;
select an animation template from a plurality of animations to apply to the image, wherein the selection of the animation is based on the detected content item or the media space;
generate an animation based on the selected animation template and an image of the user; and
send, to the client system, instructions to display the animation on the client system associated with the user.

12. The media of claim 11, wherein the selection of the animation template is further based on a current location associated with the client system.

13. The media of claim 11, wherein the content item comprises a poster.

14. The media of claim 11, wherein the animation template is selected from a plurality of animation templates, wherein each animation template corresponds to a particular content item of a plurality of content items.

15. The media of claim 11, wherein the animation template is selected further based on social graph information comprised in a social graph, the social graph comprising a plurality of nodes and a plurality of edges connecting the nodes, and wherein:
a first node corresponds to the user;
a plurality of second nodes each correspond to a particular second user, entity, or concept associated with the online social network; and
one or more edges connect the first node to one or more of the plurality of second nodes.

16. The media of claim 11, wherein the image is a first image, and further comprising:
receiving a second image from the client system, wherein the first image and the second image both comprise the content item, and the second image of the at least two images comprises a perspective of the content item that is different than the first image;
identifying, from the at least two images, an object that is common to the at least two images;
computing a difference in perspective between the at least two images that is based at least in part on a difference in size and shape between the object in the first image and the object in the second image; and
generating, based on the difference in perspective, an animation to illustrate a transition from the first image to the second image.

17. The media of claim 11, wherein the animation comprises one or more interactive elements.

18. The media of claim 11, wherein the selection of the animation template is further based on a threshold number of users interacting with the animation.

19. A system comprising:
one or more processors; and
one or more computer-readable non-transitory storage media coupled to one or more of the processors and comprising instructions operable when executed by one or more of the processors to cause the system to:
receive an image from a client system associated with a user of an online social network;
detect that a content item depicted in the image is located within a media space;
select an animation template from a plurality of animations to apply to the image, wherein the selection of the animation is based on the detected content item or the media space;
generate an animation based on the selected animation template and an image of the user; and
send, to the client system, instructions to display the animation on the client system associated with the user.

20. The system of claim 19, wherein the animation template is selected further based on social graph information comprised in a social graph, the social graph comprising a plurality of nodes and a plurality of edges connecting the nodes, and wherein:
a first node corresponds to the user;
a plurality of second nodes each correspond to a particular second user, entity, or concept associated with the online social network; and
one or more edges connect the first node to one or more of the plurality of second nodes.
